(19) United States
(12) Patent Application Publication
(10) Pub. No.: US 2017/0312867 A1
(43) Pub. Date: Nov. 2, 2017

(54) METHOD FOR REPAIRING A COMPONENT

(71) Applicant: Siemens Aktiengesellschaft, München (DE)

(72) Inventors: Matthias Kuhlee, Mülheim an der Ruhr (DE); Britta Laux, Berlin (DE)

(21) Appl. No.: 15/531,845

(22) PCT Filed: Nov. 3, 2015
(86) PCT No.: PCT/EP2015/075588

§ 371 Date: May 31, 2017

(30) Foreign Application Priority Data
Dec. 5, 2014 (DE) 10 2014 224 986.4

(51) Int. Cl. B23P 6/00

(52) U.S. Cl. CPC B23P 6/005

(57) ABSTRACT

A method for repairing a component is provided, including the following steps: introducing a recess into the component, via which recess a damaged region in the component is removed; positioning a filler body in the recess; and fixedly, i.e. non-detachably, connecting the filler body to the component, wherein the filler body is provisionally secured to the component prior to establishing the fixed connection to the component, in that a securing element is placed over the filler body and the securing element is attached to the component, wherein the securing element is removed again after the establishing of the fixed connection between the filler body and the component.

### CROSS-REFERENCE TO RELATED APPLICATIONS

This application claims priority to PCT Application No. PCT/EP2015/075588, having a filing date of Nov. 3, 2015, which is based upon and claims priority to DE Application No. 10 2014 224 986.4, having a filing date of Dec. 5, 2014 the entire contents both of which are hereby incorporated by reference.

### FIELD OF TECHNOLOGY

The following relates to a method for repairing a component.
a recess is created in the component, by means of which a damaged region in the component is removed,
a plug is positioned in the recess, and
the plug is solidly, i.e. permanently, connected to the component.

### BACKGROUND

In operation, components in various regions suffer various types of damage. This can be caused by the components being subject to dynamic and thermomechanical loads over a certain time period. For example, cracks or oxidation damage arise in the components, which can include metallic components from the turbine region such as turbine blades or the like. If crack propagation goes unchecked, this can lead to failure of the affected component. Other types of damage can also significantly endanger reliable operation. Damaged components must therefore be replaced with new components, or repaired.

Various methods for repairing damaged components are known from the prior art. For example, WO 97/21516 discloses a method of reconditioning a turbine blade having cracks in the region of the trailing edge. This involves first creating, in the turbine blade, multiple recesses, specifically slot segments, by means of which the cracks are completely removed from the turbine blade. Rod-shaped plugs, made of the same material as the turbine blade, are positioned in the resulting recesses in order to fill the latter. Plugs of this type, by means of which it is possible to re-fill a recess created for the purpose of removing damage in order to recreate the original shape of the component, are also termed coupons.

Once the rod-shaped plugs have been positioned in the recesses, these are soldered using a soldering material provided between the plugs and the wall of the recess. In that context, use is made of a solder that is metallurgically similar to the material of the turbine blade, in order to obtain a particularly thermomechanically stable connection between the plug and the component.

The method known from the prior art has proven effective for repairing a crack-affected metallic component. The turbine blade can be returned to a state in which reliable operation is ensured.

However, the known method has been found to have the partial disadvantage that it is difficult to hold the plug in a desired position during creation of the solid connection between the plug and the turbine blade that is to be repaired.

### SUMMARY

An aspect relates to developing the known method such that the plug is reliably held in a desired position during creation of the solid connection, which is in particular achieved with a soldering process.

An aspect relates to—a recess is created in the component, by means of which a damaged region in the component is removed, a plug is positioned in the recess, and the plug is solidly, i.e. permanently, connected to the component.

In the context of the method specified in the introduction, this object is achieved in that, prior to creating the solid connection with the component, the plug is provisionally secured to the component by a securing element being laid over the plug and the securing element being attached to the component, the securing element being removed once the solid connection between the plug and the component has been established.

In other words, embodiments of the invention is based on the idea of using a securing element to prevent undesired slipping of a plug positioned in the recess created in order to remove damage. To that end, the securing element is laid from outside around the plug that is positioned in the recess, such that it grips the plug at least partially externally, and it is then attached to the component, this being done preferably by means of a connection which can undone again relatively easily and with a minimum of residue.

During the subsequent establishment of the final solid connection between the plug and the component, the plug is held provisionally on the component, wherein the securing element used according to embodiments of the invention almost adopts the function of a holding clip for the plug. The solid connection that is to be created is in particular a material-bonded connection between the plug and the component, such as can be obtained for example by means of a soldering process.

The securing element is a particularly simple, rapid and cost-effective option for provisionally securing the plug during creation of the solid connection. The reliable positioning of the plug, which is ensured according to embodiments of the invention, in particular prevents unsatisfactory repaired components being obtained as a consequence of undesired slipping of the plug.

After the end of the process for creating the solid connection, the securing element can simply be removed again from the component.

The plug can for example be solidly connected to the component by means of a high-temperature soldering process. In that context, various soldering materials can be used. Examples include soldering foils, PSPs (pre-sintered preforms) and Flex Tapes. The soldering material is expediently provided, in a manner known per se, between the inner wall of the recess and the plug that is positioned in the recess. During soldering at a temperature of for example about 1200° C., the soldering material melts so as to establish a material-bonded joint between the plug positioned in the recess and the component.

The creation of one or more recesses for removing the damaged material regions can be carried out in a manner known per se, for example by eroding or milling.

Depending on the shape and/or scale of the damage to the component, it can be necessary to produce relatively large recesses—or multiple recesses—in the component in order to remove the damage. In particular in these cases, multiple plugs can then also be used, with each plug being provisionally attached using at least one securing element, in the manner according to embodiments of the invention.

Furthermore, it can also be expedient, depending on the size and shape of the plug used, to provisionally attach a single plug to the component using more than one securing element.

Thus, one embodiment of the method according to the invention is characterized in that two or more securing elements are laid over the plug and are attached to the component in order to provisionally secure the plug to the component.

The use of more than one securing element for a plug is in particular advantageous if the plug has a relatively large extent in at least one direction. In this case, the plug can for example be provisionally secured to the component using multiple securing elements that are positioned at a distance from one another. For example, an elongate plug can be held using two securing elements which overlap the former at each of the two opposite end regions, and which are each attached to the component.

Various materials can be suitable for the securing element. If the solid connection between the plug and the component is created by heating, as is the case in the context of a soldering process, then it is expedient to choose, for the securing element, a material which remains sufficiently stable at these temperatures to ensure provisional securing.

One embodiment of the method according to the invention is characterized in that use is made of a securing element made of a material whose thermal expansion coefficient is lower than the thermal expansion coefficient of the material of the component and/or of the plug.

A corresponding material choice is particularly advantageous since this ensures that, in the context of creating the solid connection between the plug and the component, which can involve a substantial rise in temperature for example in the context of a soldering procedure, the material of the component and/or of the plug expands more than the material of the securing element. This means that the plug, which expands more during creation of the connection, is pressed against the securing element and is thus particularly reliably held at a desired position in the recess.

It can further be provided that use is made of a securing element made of metal, in particular of molybdenum or a molybdenum alloy. These materials have proven to be suitable for the securing element(s) used according to embodiments of the invention.

In a refinement of the method according to embodiments of the invention, furthermore, a component made of metal, in particular a nickel-based component, is repaired and/or a plug made of metal, in particular a nickel-based plug, is used.

The fact that the securing element has a lower thermal expansion coefficient than the component and/or the plug is obtained for example with a combination of a securing element made of molybdenum or a molybdenum alloy on one hand and a component and/or plug made of a nickel-based material on the other hand. This combination thus makes it possible, in the manner described above, to achieve a beneficial difference in the thermal expansion coefficients and, as a consequence thereof, particularly reliable retention of the plug during creation of the solid connection under heating.

The securing element also has, in particular at least in one direction, an extent which enables it to completely encompass the plug positioned in the recess, and to extend past this on at least one side of the plug. In the region extending beyond the plug, it is then simple, for the provisional securing, to establish a connection between the securing element and the component. Preferably, the securing element encompassing the plug projects beyond the plug on two sides, and is connected to the component on both sides.

One embodiment of the method according to the invention provides that use is made of an elongate securing element. The use of a securing element that is more extensive in the longitudinal direction than in the transverse direction is particularly suitable since it can straddle the longitudinal direction of the plug and project beyond this for attachment, while the extent in the transverse direction can be relatively small in order to save material.

Furthermore, in an advantageous configuration, the securing element is relatively thin. Thus, another embodiment of the method according to the invention is characterized in that use is made of a securing element which has a thickness of less than 1 mm, in particular of less than 0.5 mm, preferably of less than 0.3 mm.

The use of a thin securing element has the advantage that the securing element can be secured to the component in a particularly simple and non-damaging manner. This can be effected for example by resistance spot-welding of the securing element. In that context, with a securing element having a thickness of less than 1 mm, a relatively low current and a short holding time are sufficient to spot-weld the securing element to the component. A non-damaging attachment of this type avoids damage to the component material at the corresponding locations. Furthermore, a connection thus produced between the securing element and the component is also simple to undo.

If the securing element is relatively thin in comparison to the plug, it can be attached to the component, for example by spot-welding, in a substantially less-damaging manner than would be possible for the plug itself. If one were to spot-weld the plug directly to the component, in particular in order to prevent slipping during the subsequent high-temperature soldering process, it would generally be necessary to use larger currents and a longer holding time. This would also cause greater damage, for example crater formation on the component, which would have to be removed again afterward. The use, according to embodiments of the invention, of a securing element prevents these drawbacks entirely.

It is provided in a development of embodiments of the invention that use is made of a securing element made of a foil. Using a foil, it is easy to create a relatively thin securing element. It is for example possible to produce foil strips by cutting strips—in particular rectangular strips—of a suitable size from a foil sheet. A securing element made of a foil can be attached to the component in a particularly non-damaging manner, for example by spot-welding.

In that context, use can be made, as securing element, of a foil strip having a thickness in the range from 0.05 mm to 0.2 mm, in particular in the range from 0.05 mm to 0.15 mm, and preferably in the range from 0.08 mm to 0.12 mm.

Foil strips of this thickness can be attached to the component in a particularly simple and non-damaging manner by spot-welding. Owing to the very low thickness of the foil strips, only a very low current and a particularly short holding time are required to spot-weld the foil strips.

Another embodiment of the method according to the invention is characterized in that the securing element is attached to the component by spot-welding.

In particular in the case that use is made of an elongate securing element, it can be provided that both free ends of the elongate securing element are attached to the component by creating at least one spot-weld connection. When the securing element is placed over the plug, the two free ends project beyond the plug and can easily by spot-welded to the component.

A development of embodiments of the invention also provides that use is made of a plug whose shape matches the shape of the recess. The plug preferably has a cross-sectional shape which corresponds to the cross-sectional shape of the created recess, wherein the size of the cross-sectional area of the plug is slightly less than that of the recess at least in one direction, preferably in terms of width. In terms of height, the plug is—in an expedient configuration—dimensioned such that, when it is positioned in the recess and in particular together with soldering material, it projects from the component, at least slightly beyond the upper rim of the recess. This projecting arrangement ensures that the plug entirely fills the recess, even in the event that the soldering material gives way somewhat during the soldering process and, for example, that the plug sinks slightly. In the event that the plug still projects slightly beyond the recess after creation of the solid connection, in particular after the end of the soldering process, it is possible to carry out finishing in order to once again obtain a smooth component surface. However, having a hole at the component surface, as a consequence of using too small a plug, should expediently be avoided.

It is for example possible to create a recess with a rectangular or semi-circular cross section, and to position therein a plug with a rectangular or semi-circular cross section having the above-described expedient dimensions. Creation of the solid connection, and possibly slight finishing of the surface, results in a repaired component which corresponds in shape to the original, undamaged shape.

According to another embodiment, once the securing element has been removed, the component is finished, preferably ground, in at least one region in which the securing element was attached to the component. This removes minor material damage such as might be caused by creating the provisional attachment of the securing element to the component, for example by spot-welding. The result is a component with a particularly smooth surface.

Finally, it can be provided that the securing element is additionally attached to the plug and, in particular, once the securing element has been removed, the plug can be finished, preferably ground, in at least one region in which the securing element was attached to the plug. If the securing element placed over the plug is for example attached not only to the component on both sides of the plug, but optionally also to the plug itself, an additional hold can be achieved.

### BRIEF DESCRIPTION

Some of the embodiments will be described in detail, with reference to the following figures, wherein like designations denote like members, wherein:

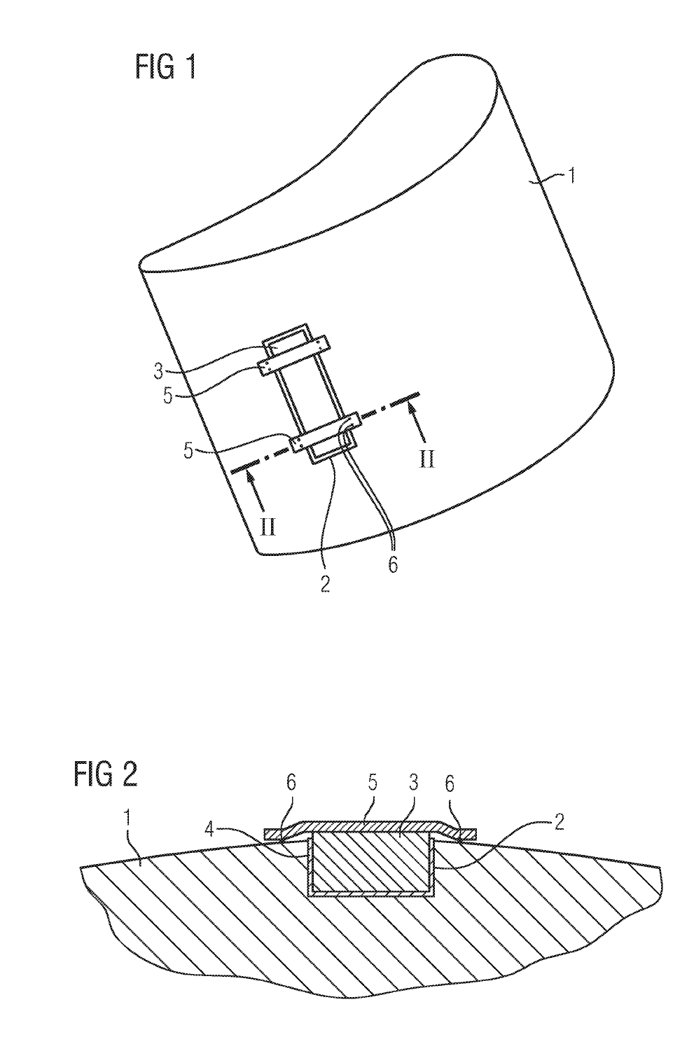

FIG. 1 is a schematic representation of a component that is to be repaired, with a plug which is positioned in a recess and is provisionally attached to the component by means of two securing elements, in the manner according to embodiments of the invention; and

FIG. 2 is a sectional representation of the component shown in FIG. 1, showing the recess, the plug and the securing elements.

### DETAILED DESCRIPTION

FIG. 1 shows, in a schematic representation, a component that is to be repaired, in the present case a turbine blade 1 made of a nickel-based base material.

The turbine blade 1 suffered damage during operation.

For that reason, for repair a prismatic recess 2 has been introduced into the turbine blade 1 by milling, by means of which the damaged region of the turbine blade 1 has been removed.

In order to re-fill the recess 2 created to remove the damage, and thus reproduce the original shape of the turbine blade 1, an also prismatic plug 3 made of a nickel-based material is positioned in the recess 2.

The plug 3 is dimensioned such that it is slightly narrower than the recess 2. Furthermore, the height of the plug 3 is dimensioned such that the plug 3 projects upward slightly out of the recess 2 when it is positioned in the recess 2 together with a soldering material, in this case a soldering foil 4. The soldering foil 4 is provided between the wall of the recess 2 and the plug 3, which is shown clearly in the sectional representation of FIG. 2.

In the context of repairing the turbine blade 1, a solid, i.e. permanent, connection is to be created between the plug 3 positioned in the recess 2 and the surrounding turbine blade 1. In the present case, there is provided for this a high-temperature soldering process which involves heating to approximately 1200° C. This causes the material of the soldering foil 4 to melt, thus creating a material-bonded join between the plug 3 and the turbine blade 1.

It has proven difficult to keep the plug 3 in its desired position during the soldering process.

In order to prevent undesired slipping of the plug 3 in the recess 2, embodiments of the invention provides that, prior to creating the solid connection between the turbine blade 1 and the plug 3, the latter is provisionally secured by means of two securing elements 5.

Specifically, each of the two securing elements 5 are elongate foil strips made of molybdenum. In order to create the securing elements 5, a 0.1 mm-thick molybdenum foil was cut into strips. The securing elements 5 therefore each have a thickness of 0.1 mm.

The two securing elements 5 are placed over the plug 3 such that their longitudinal axes are oriented transversely to that of the plug 3. The securing elements 5 reach over the plug 3 in its transverse direction, and thus their longitudinal direction, entirely and each extend beyond the plug 3 on both longitudinal sides of the latter. In the regions projecting laterally beyond the plug 3, the two securing elements 5 are each spot-welded to the turbine blade 1 at two punctiform welding locations 6.

In that context, the two securing elements 5 are spot-welded to the turbine blade 1 such that there is no longer any play between these elements and the plug 3. They both bear against the upper side of the plug 3 and thus hold the latter in the recess 2.

Since the securing elements 5 have a thickness of just 0.1 mm, only a relatively very low current and a short holding time are required to spot-weld the securing elements 5 by spot-welding to the turbine blade 1 at the corresponding locations. Thus, once the securing elements 5 have been placed over the plug 3, they can be attached to the turbine blade 1 particularly rapidly and simply.

Once the securing elements 5 have been attached, a solid connection between the plug 3 and the turbine blade 1 can be created by means of a high-temperature soldering process.

Creating the solid connection involves heating to approximately 1200° C. in order to obtain the material-bonded join between the turbine blade 1 and the plug 3. Since molybdenum has a lower thermal expansion coefficient than the turbine blade 1 and the plug 3 made of the nickel-based material, the securing elements 5 secure themselves automatically during the soldering procedure. The plug 3 presses against the securing elements 5 due to its greater expansion with respect thereto. As a result, the plug 3 is particularly reliably held in the desired position in the recess 2.

After completion of the high-temperature soldering process, the securing elements 5 can be easily, for example manually, removed from the turbine blade 1. Since the relatively thin securing elements 5 can be attached to the turbine blade 1 in a particularly non-damaging manner by spot-welding, the turbine blade 1 suffers little or no damage in the regions of the punctiform welding locations 6. If necessary, these locations can optionally be briefly re-ground after removal of the securing elements 5 in order to once again obtain a particularly smooth surface of the turbine blade 1.

In the event that, after the end of the high-temperature soldering process, the plug 3 still projects slightly upward beyond the recess 2, it is moreover readily possible to once again smooth the surface of the turbine blade 1 by grinding or another type of finishing.

By using the method according to embodiments of the invention for repairing a component, it is possible to return the originally damaged turbine blade 1 to a fully functional state. In that context, the use, according to embodiments of the invention, of the securing elements 5 makes it possible to reliably hold the plug 3 in the desired position during creation of the solid connection between it and the turbine blade 1. This reliably avoids slipping of the plug 3, which can produce an unsatisfactory result after the soldering procedure.

Although the invention has been described and illustrated in detail by way of the preferred exemplary embodiment, the invention is not restricted by the disclosed examples and other variations can be derived herefrom by a person skilled in the art without departing from the scope of protection of the invention.

For the sake of clarity, it is to be understood that the use of ‘a’ or ‘an’ throughout this application does not exclude a plurality, and ‘comprising’ does not exclude other steps or elements.

1-15. (canceled)

16. A method for repairing a component, comprising:
creating a recess in the component, by means of which a damaged region in the component is removed,
positioning a plug in the recess; and
permanently connecting the plug to the component;
wherein, prior to creating a permanent connection with the component, the plug is provisionally secured to the component by a securing element being laid over the plug and the securing element being attached to the component, the securing element being removed once the permanent connection between the plug and the component has been established,
and in which use is made of an elongate securing element.

17. The method as claimed in claim 16, wherein the securing element which has a thickness of less than 1 mm.

18. The method as claimed in claim 16, wherein the securing element made of a foil.

19. The method as claimed in claim 17, wherein the securing element is a foil strip having a thickness in the range from 0.08 mm to 0.12 mm.

20. The method as claimed in claim 16, wherein the securing element is made of a material whose thermal expansion coefficient is lower than a thermal expansion coefficient of the material of the component and/or of the plug.

21. The method as claimed in claim 16, wherein the securing element is made of molybdenum or a molybdenum alloy.

22. The method as claimed in claim 16, wherein the component is made of a nickel-based component and is repaired using the plug made of a nickel-based plug.

23. The method as claimed in claim 16, wherein the securing element is attached to the component by spot-welding.

24. The method as claimed in claim 23, wherein two free ends of the securing element are attached to the component by creating at least one spot-weld connection.

25. The method as claimed in claim 16, wherein two or more securing elements are laid over the plug and are attached to the component in order to provisionally secure the plug to the component.

26. The method as claimed in claim 16, wherein once the securing element has been removed, the component is finished in at least one region in which the securing element was attached to the component.

27. The method as claimed in claim 16, wherein the securing element is additionally attached to the plug and, once the securing element has been removed, the plug is finished in at least one region in which the securing element was attached to the plug.

28. The method as claimed in claim 16, wherein a shape of the plug matches a shape of the recess.

29. The method as claimed in claim 16, wherein the plug is permanently connected to the component by a high-temperature soldering process.
